(19) United States
(12) Patent Application Publication
(10) Pub. No.: US 2015/0074583 A1
(43) Pub. Date: Mar. 12, 2015

(54) METHOD AND DEVICE FOR CORRECTING MAP VIEW

(71) Applicant: Samsung Electronics Co., Ltd., Suwon-si (KR)

(72) Inventors: Shiying WANG, Nanjing (CN); Tianxiang QIN, Nanjing (CN); Binde CHEN, Nanjing (CN)

(73) Assignee: SAMSUNG ELECTRONICS CO., LTD., Suwon-si (KR)

(21) Appl. No.: 14/482,611

(22) Filed: Sep. 10, 2014

(30) Foreign Application Priority Data
Sep. 10, 2013 (CN) 201310408281.X

(51) Int. Cl. G06F 3/0484; G06F 3/0481

(52) U.S. Cl. CPC G06F 3/04842; G06F 3/04817
USPC 715/771

(57) ABSTRACT

A method for correcting a map view based on a point of interest and a correcting device are provided, wherein the method includes: displaying, a map view and the point of interest on a screen; and correcting, the map view based on a position of the point of interest on the screen when the map view changes.

### TECHNICAL FIELD

This disclosure generally relates to a method for correcting a view of electronic map and a correcting device, and more particularly, to a method for correcting a map view based on a point of interest and a correcting device thereof.

### BACKGROUND

With rapid development of an electronic and communication technology, various service functions are constantly integrated on a terminal such as a mobile phone. Currently, an electronic map and navigation function can already be implemented on the terminal to provide a user with convenient. The user can identify a location, search a path for a destination, or search a point of interest (POI), etc through the electronic map. In the electronic map, the POI can be a restaurant, a supermarket, a shopping mall, a bank, a subway station, etc.

In a current technology, when the user searches a point of interest through electronic map, the user have to select an appropriate map view and perform a series of complicated operations such as a position orientation, zooming, moving map, etc to reach the point of interest. However, because of a limitation of a screen size of the terminal and operation inconvenience, trouble is brought to the user.

### SUMMARY

In view of the above problem, the object of the present invention is to provide a correcting mechanism in an operation process of the map view on the electronic map, to enable the user to reach the position of the point of interest faster and more accurately and to improve operation convenience of the user.

In order to achieve the above purpose, according to an aspect of the present invention, a method for a map view correction is provided, wherein the method includes: displaying a map view and a point of interest on a screen; correcting the map view based on a position of the point of interest on the screen according to a user input selecting a point on the map view; and displaying the corrected map view and the point of interest on the screen.

In the method, the correcting the map may comprise: reloading a map in response to the user input selecting the point, the map having the point selected by the user at the center of the screen, and the corrected map view may be displayed based on the reloaded map.

In the method, the correcting the map view may comprise: reloading a map with a position of the point of interest at the central point of the screen when the position of the point of interest is within a predetermined range of the point selected by the user input, and the corrected map may be displayed based on the reloaded map.

In the method, the correcting the map view may comprise: determining, when multiple points of interest are within a predetermined range of the point selected by the user, at least one optimum points of interest by calculating distances between the point selected by the user and the multiple points of interest.

In the method, when only one optimum point is obtained based on the determining, the correcting the map view may further comprise: reloading the map with the optimum point of interest at the central point of the screen, and the corrected map view may be displayed based on the reloaded map.

In the method, wherein, when multiple optimum points of interest are obtained based on the determining, the correcting the map view may further comprise: selecting a final optimum point of interest from among the multiple optimum points of interests by an order of a priority of an X-axis positive direction, an X-axis negative direction, a Y-axis positive direction and a Y-axis negative direction from high to low, and reloading the map with the final optimum point of interest at the central point of the screen, and the corrected map view may be displayed based on the reloaded map.

In the method, the method may further comprises: representing a range of a predetermined distance, as an icon, from a point selected by the user input, where the icon is an annulus having a direction or other determined shape, and the correcting the map view may comprise correcting the map view based on the represented icon.

According to another aspect of the present invention, a device for a map view correction based on a point of interest is provided, wherein the device includes: a displaying module, configured to display a map view and a point of interest on a screen; and a map view correcting module, configured to correct the map view based on a position of the point of interest on the screen according to a user input selecting a point on the map view, wherein the displaying module is further configured to display the corrected map view and the point of interest on the screen.

The map view correcting module may be further configured to reload a map in response to the user input selecting the point, the map having the point selected by the user at the center of the screen, and the corrected map view may be displayed based on the reloaded map.

The map view correcting module may be further configured to reload a map with the position of the point of interest at the central point of the screen, when the position of the point of interest is within a predetermined range of the point selected by the user input, and the corrected map may be displayed based on the reloaded map.

The map view correcting module may be further configured to determine, when multiple points of interest are within a predetermined range of the point selected by the user, at least one optimum points of interest by calculating distances between the point selected by the user and the multiple points of interest.

When only one optimum point is obtained based on the determination of the map view correcting module, the map view correcting module may be further configured to reload the map with the optimum point of interest at the central point of the screen, and the corrected map view may be displayed based on the reloaded map.

When multiple optimum points of interest are obtained based on the determination of the map view correcting module, the map view correcting module may be further configured: to select a final optimum point by an order of a priority of an X-axis positive direction, an X-axis negative direction, a Y-axis positive direction and a Y-axis negative direction from high to low, and to reload the map with the final optimum point of interest at the central point of the screen, and the corrected map view may be displayed based on the reloaded map.

The map view correcting module may be further configured to represent a range of a predetermined distance, as an icon, from the point selected by user, where the icon is an annulus having a direction or other determined shape, and the correcting the map view may comprise correcting the map view based on the represented icon.

### BRIEF DESCRIPTION OF DRAWINGS

The above and other objects and features of embodiments of the present invention will appear more fully hereinafter from a consideration of the following description taken in connection with the accompanying drawings.

FIG. 1 illustrates a block diagram of a map view correction device according to an embodiment of the present invention.

FIG. 2 illustrates a flowchart of a method for a map view correction according to an embodiment of the present invention.

FIG. 3 illustrates a schematic map with a highlighted point of interest covered by an icon according to an embodiment of the present invention.

FIG. 4 illustrates a schematic map of a map view that has been automatically corrected by taking a highlighted point of interest as a view central point according to an embodiment of the present invention.

### DESCRIPTION OF EXEMPLARY EMBODIMENTS

The embodiments of the present invention will be described in detail hereinafter with reference to the accompanying drawings.

A map view correction device based on a point of interest according the present invention includes: a displaying module configured to display a map view and the point of interest on a screen; and a map view correcting module configured to correct the map view based on a position of the point of interest on the screen when the map view changes.

The present invention will be described in detail hereinafter with reference to specific embodiments.

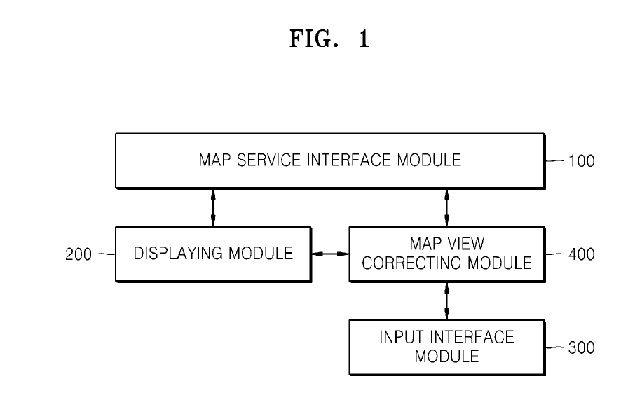

Referring to FIG. 1, the map view correction device of an embodiment of the present invention can be arranged in a terminal device, wherein the map view correction device includes a map service interface module 100, a displaying module 200, an input interface module 300 and a map view correcting module 400.

The map service interface module 100 is used for sending a loading request of a map and a point of interest to a map service system, so as to obtain information of the map and the point of interest to load the map and the point of interest. The displaying module 200 is used for displaying the map view and the point of interest on a screen. The input interface module 300 is used for receiving an input signal from a user through an input terminal. And the map view correcting module 400 is used for correcting the map view based on a position of the point of interest on the screen when the map view changes.

More specifically, the map service interface module 100 may receive the request from the map view correcting module 400, and send the request to the map service system, wherein the map service system may be from Google Map, Baidu Map, etc, from a web service, or may also be from a local GIS system. In addition, the map service interface module 100 may send map data returned from the map service system and a coordinate of the point of interest to the displaying module 200.

The displaying module 200 may display the map and the point of interest. When the displaying module 200 receives data returned from the map service system, if the returned map data is a map image that can be visualized, it is displayed directly, otherwise, the returned map data is transformed into a map image that can be displayed directly and the map image is displayed on the screen. After a geographic position of the point of interest is obtained, the displaying module 200 calculates the position of the point of interest in the map, wherein the displaying module 200 reloads the map by taking a point set or selected by the user as a focal point and taking the focal point as a central point of the screen, and displays a corresponding map view.

The input interface module 300 may receive a signal from the input terminals and send the signal to the map view correcting module 400. After receiving the signal sent by these terminals, the input interface module 300 may send the signal to the map view correcting module 400. In addition, the input interface module 300 may receive a point taken as a focal point which is set or selected by the user on the map.

The map view correcting module 400 may receive a signal from the input interface module 300, and request the map service interface module 100 to obtain new map data and information of the point of interest according to the signal. The map view correcting module 400 may automatically calculate whether the map view correction is needed, and if needed, the map service interface module 100 is re-requested to correct the map view.

Specifically, when the point set or selected by the user is taken as the focal point, and when a point of interest is determined to be within a range of the focal point nearby, the map view correcting module 400 reloads the map by taking the point of interest as the central point of the screen, and displays the corresponding map view and the point of interest. When multiple points of interest are determined in the range of the focal point nearby, the map view correcting module 400 calculates optimum point(s) of interest. When only one optimum point of interest is obtained, the map view correcting module 400 reloads the map by taking the optimum point of interest as the central point of the screen, and displays the corresponding map view and the point of interest.

A method for a map view correction based on a point of interest according to an embodiment of the present invention includes: displaying a map view and a point of interest on a screen; and correcting the map view based on a position of the point of interest on the screen when the map view changes.

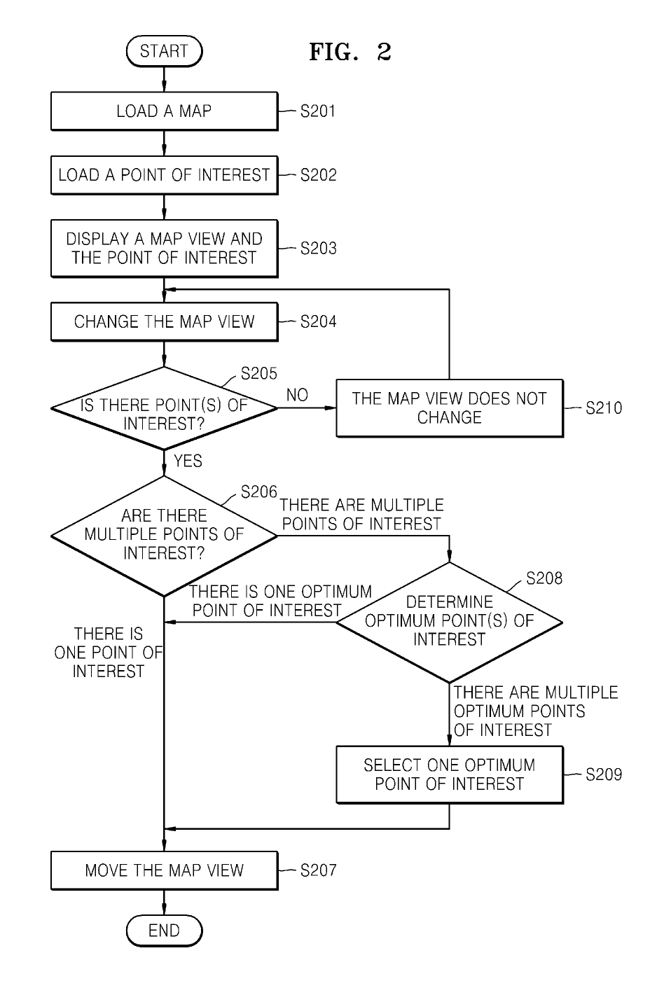

A method for correcting an electronic map view based on the point of interest is described in detail below with reference to FIG. 2.

In an embodiment, a map view correction device according to an embodiment of the present invention is arranged in an intelligent television that can serve as a screen to display an electronic map and a point of interest, or can serve as a processing terminal to request information from a map service provider. A remote control of the intelligent television through which the user may input an instruction can serve as a non-direction input terminal. Before an operation starts, the intelligent television may be connected to the internet in advance.

As shown in the FIG. 2, in step S201, according to a request signal for loading a map, input by the user form the input interface module 300, the map service interface module 100 loads a corresponding map. Specifically, the map service interface module 100 may load the corresponding map in accordance with the map service system and a map type.

In step S202, the map service interface module 100 loads the newest data information of the point of interest from the map service system, wherein the information includes at least latitude and longitude information. The map service interface module 100 transforms the latitude and longitude information into corresponding position coordinate information through coordinate transformation, so as to form a set of a series of points of interest.

In step S203, the displaying module 200 displays the map view and the points of interest. When map information received by the displaying module 200 is a visualized map image, the map image is displayed on the screen. According to another embodiment, the displaying module 200 transforms the received map information into a visualized map image and displays the transformed map image. Furthermore, according to an embodiment, the displaying module 200 marks the points of interest in a form of bubble based on information of position coordinate on the map image, wherein the bubble refers to photo information when a zoom level of the map reaches a certain level.

In step S204, the user changes the map view through the input interface module 300. Specifically, the input interface module 300 receives an input signal of changing the map view from the user through the input terminal. Then the map view correction module 400 reloads the map by taking a determined point based on the input signal as the focal point (that is, by taking the point set or selected by the user as the focal point) and taking the focal point as the central point of the screen through controlling the map service interface module 100. Further, the map view correction module 400 controls the displaying module 200 to display the corresponding map view thereby changing the map view.

In step S205, the map view correction module determines whether there is the point of interest within a predetermined range of the focal point nearby. Specifically, an annular icon having a direction is displayed in a predetermined range of the focal point nearby.

If it is determined that there is no point of interest in the step S205 (namely there is no point of interest within the annular icon), the map view does not change in step S201.

If it is determined that the point(s) of interest exists in the step S205 (namely the point(s) of interest exists within the annular icon), whether there are multiple points of interest is determined in step S206.

When it is determined that there is a single point of interest in the step S206, that is, there is one point of interest covered by the icon, in step S207, the map view correction module 400 takes the point of interest as the focal point (the focal point is the central point of displaying screen) to move the map view. For example, the displaying module 200 may highlight the point of interest, reload the map by taking the point of interest as the central point of the screen through controlling the map service interface module 100, and control the displaying module 200 to display the corresponding map view and the point of interest.

When it is determined that multiple points of interest exist in the step S206, that is, when there are multiple points of interest covered by the icon, optimum point(s) of interest is determined in step S208. Specifically, the map view correction module 400 may control the displaying module 200 to highlight the multiple points of interest, and obtain the optimum point of interest based on the distance between the focal point and the point of interest (such as by a nearest priority principle in linear distance).

The nearest priority principle in linear distance is as follow: calculating distances of the multiple points of interest from the central point of the screen; and taking the point(s) of interest corresponding to calculated minimum distance as the optimum point(s) of interest. For example, in a two-dimensional space, suppose coordinates of the central point of the screen are (x, y) and coordinates of two points of interest are (x1, y1) and (x2, y2) respectively, and by comparing the values of \sqrt{(x1−x)²+(y1−y)²} and \sqrt{(x2−x)²+(y2−y)²}, the point(s) of interest corresponding to the minimum value is taken as the optimum point of interests.

When only one optimum point is obtained, in step S207, the map view correction module takes the optimum point of interest as the focal point (the focal point is the central point of displaying screen) to move the map view. For example, the map service interface module 100 is controlled to reload the map by taking the optimum point of interest as the central point of the screen, and the displaying module 200 is controlled to display the corresponding map view and the optimum point of interest.

When multiple optimum points of interest are obtained, in step S209, the map view correction module selects one optimum point of interest by the principle that the distance in X-direction is a first priority and that in Y-direction is the second (namely by an order of a priority of an X-axis positive direction, an X-axis negative direction, a Y-axis positive direction and a Y-axis negative direction from high to low). Subsequently, in step S207, the map view correction module takes the optimum point of interest as the focal point (the focal point is the central point of displaying screen) to move the map view. For example, the map service interface module 100 is controlled to reload the map by taking the optimum point of interest as the central point of the screen, and the displaying module 200 is controlled to display the corresponding map view and the optimum point of interest. Hence, the user may quickly browse detailed information of the point of the interest through the terminal.

An embodiment of the present invention with an intelligent television with a terminal (or a terminal device), with a remote control and with an input terminal is described above. However, the present invention is not limited thereto. The terminal may include a fixed terminal such as intelligent terminal like an intelligent television, and a mobile terminal such as: a personal digital cellular (PDC) phone, a personal communication service (PCS) phone, a personal handy-phone system (PHS) phone, a code division multiple access (CDMA)-2000 (1X,3X) phone, a wideband CDMA phone, a dual-frequency/dual-mode phone, a global system for mobile communication (GSM) phone, a mobile broadband system (MBS) phone, satellite /ground digital multimedia broadcasting (DMB) phone, an intelligent phone, a cellular phone, a personal digital assistant (PDA), a MP3 player, a portable media player (PMP) and a car navigation system (such as a global positioning system) etc. Furthermore, the input terminal may include such as a touch screen, a remote control, a mouse, a keyboard, and so on.

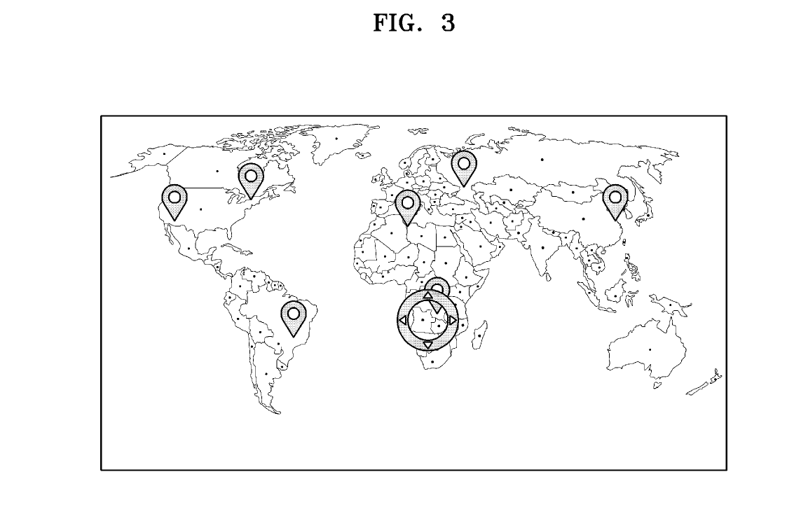

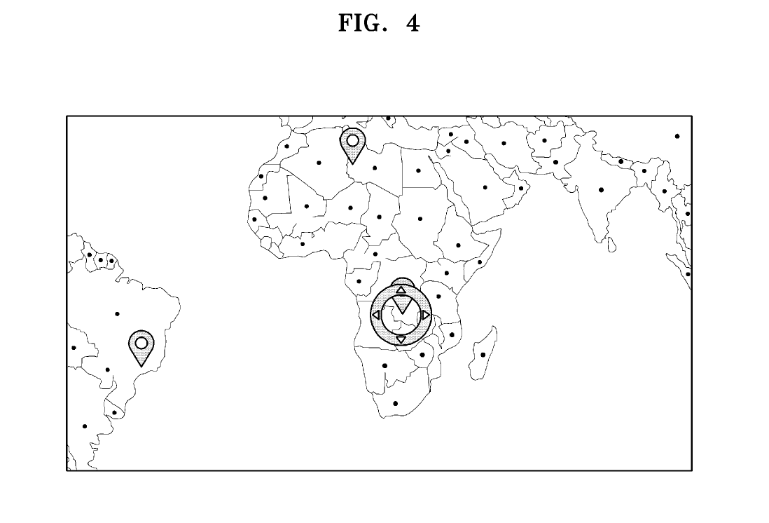

FIG. 3 illustrates a map view where a point of interest is not corrected, and FIG. 4 illustrates a map view that is corrected according to a point of interest of an embodiment of the present invention.

Referring to FIG. 3, when the user inputs points of interest that interests him/her to the intelligent television by a remote control, and when there is a point of interest that falls within a range covered by an annular icon, then the map view correction device of an embodiment of the present invention highlights the point of interest.

Referring to FIG. 4, an embodiment of a map view correction device of the present invention automatically corrects the map view, that is, the map view is translated and zoomed out by taking a highlighted point of interest as a view central point, to make it easier for the user to browse the information of the point of interest that interests him/her in an appropriate view.

By the method and the device for the map view correction of an embodiment of the present invention, the map view is automatically corrected according to the position of the point of interest, which makes the map operation process more humanized.

In the case described above, the point of interest is marked in a form of bubble, but the present invention is not limited thereto, and the point of interest can also be marked in any other form. Furthermore, the case of the annular icon is described above, but the present invention is also not limited thereto, and the icon in any other shape can also be adopted.

The present invention is not limited to the embodiments described above, and various variations and modification may be possible without departing from the spirit and scope of the present invention.

What is claimed is:

1. A method for correcting a map view, comprising:
displaying a map view and a point of interest on a screen;
correcting the map view based on a position of the point of interest on the screen according to a user input selecting a point on the map view; and
displaying the corrected map view and the point of interest on the screen.

2. The method of claim 1, wherein
the correcting the map comprises: reloading a map in response to the user input selecting the point, the map having the point selected by the user at the center of the screen, and
the corrected map view is displayed based on the reloaded map.

3. The method of claim 1, wherein
the correcting the map view comprises: reloading a map with a position of the point of interest at the central point of the screen when the position of the point of interest is within a predetermined range of the point selected by the user input, and
the corrected map is displayed based on the reloaded map.

4. The method of claim 1, wherein
the correcting the map view comprises: determining, when multiple points of interest are within a predetermined range of the point selected by the user, at least one optimum points of interest by calculating distances between the point selected by the user and the multiple points of interest.

5. The method of claim 4, wherein, when only one optimum point is obtained based on the determining,
the correcting the map view further comprises: reloading the map with the optimum point of interest at the central point of the screen, and
the corrected map view is displayed based on the reloaded map.

6. The method of claim 4, wherein, when multiple optimum points of interest are obtained based on the determining,
the correcting the map view further comprises:
selecting a final optimum point of interest from among the multiple optimum points of interests by an order of a priority of an X-axis positive direction, an X-axis negative direction, a Y-axis positive direction and a Y-axis negative direction from high to low, and
reloading the map with the final optimum point of interest at the central point of the screen, and
the corrected map view is displayed based on the reloaded map.

7. The method of claim 1, further comprises:
representing a range of a predetermined distance, as an icon, from a point selected by the user input, where the icon is an annulus having a direction or other determined shape, and
wherein the correcting the map view comprises correcting the map view based on the represented icon.

8. A device for correcting a map view, comprising:
a displaying module, configured to display a map view and a point of interest on a screen; and
a map view correcting module, configured to correct the map view based on a position of the point of interest on the screen according to a user input selecting a point on the map view, and
wherein the displaying module is further configured to display the corrected map view and the point of interest on the screen.

9. The device of claim 8, wherein
the map view correcting module is further configured to reload a map in response to the user input selecting the point, the map having the point selected by the user at the center of the screen, and
the corrected map view is displayed based on the reloaded map.

10. The device of claim 8, wherein
the map view correcting module is further configured to reload a map with the position of the point of interest at the central point of the screen, when the position of the point of interest is within a predetermined range of the point selected by the user input, and
the corrected map is displayed based on the reloaded map.

11. The device of claim 8, wherein
the map view correcting module is further configured to determine, when multiple points of interest are within a predetermined range of the point selected by the user, at least one optimum points of interest by calculating distances between the point selected by the user and the multiple points of interest.

12. The device of claim 11, wherein, when only one optimum point is obtained based on the determination of the map view correcting module,
the map view correcting module is further configured to reload the map with the optimum point of interest at the central point of the screen , and
the corrected map view is displayed based on the reloaded map.

13. The device of claim 11, wherein, when multiple optimum points of interest are obtained based on the determination of the map view correcting module,
the map view correcting module is further configured:
to select a final optimum point by an order of a priority of an X-axis positive direction, an X-axis negative direction, a Y-axis positive direction and a Y-axis negative direction from high to low, and
to reload the map with the final optimum point of interest at the central point of the screen, and
the corrected map view is displayed based on the reloaded map.

14. The device of claim 8, wherein
the map view correcting module is further configured to represent a range of a predetermined distance, as an icon, from the point selected by user, where the icon is an annulus having a direction or other determined shape, and
wherein the correcting the map view comprises correcting the map view based on the represented icon.
